(19) United States
(12) Patent Application Publication
(10) Pub. No.: US 2004/0233233 A1
(43) Pub. Date: Nov. 25, 2004

(54) System and method for embedding interactive items in video and playing same in an interactive environment

(76) Inventors: Carole T. Salkind, Rockaway, NJ (US); William J. Fulco, Santa Monica, CA (US); Jorge V. Geaga, Los Angeles, CA (US)

Correspondence Address: David L Hoffman, LAW OFFICES OF DAVID L. HOFFMAN, Suite 422, 27023 McBean Parkway, Valencia, CA, 91355, US

(21) Appl. No.: 10/443,301

(22) Filed: May 21, 2003

(51) Int. Cl. G09G 5/00

(52) U.S. Cl. 345/719

(57) ABSTRACT

A system and method includes, according to one embodiment, an embedding system where, in a video series of images, a temporal and physical location of an object's image with respect to a reference may be stored in association with other data of potential interest to a viewer of the video. The object is tracked throughout a scene or segment of the video using a neural net, preferably multilayered and preferably using multiple input parameters. The system and method also includes a system for playing such a video, allowing a viewer to select an object, whether in real time or later, in the video, and using the information associated with the object's image to link to information preferably related to or of relevance to the selected image.

### BACKGROUND OF THE INVENTION

1. Field of the Invention

The present invention relates to a system and method for embedding interactive items in video and playing same in an interactive environment.

2. Description of the Related Art

With the advent of the internet, many computer users have become accustomed to the process know as “surfing the web.” Generally, this involves loading a web site on to one's computer screen, and then selecting a desired one of multiple items on the screen. When the user clicks on the desired item, if it is “hot”, i.e., a link, the user then goes to a new web page. Sometimes this web page may only show on a portion of the user's screen, leaving the underlying web page to occupy a portion of the screen (a split screen), and other times it replaces the web page. In the new page, the user then may click on further selected items and go to another web page. The user can usually follow the trail back to the original page by hitting the “back button” on the browser and sometimes by means of following links back to the original page. On some web pages, the text or portions of the text itself and/or the images contain a link or hyperlink to another web page or a “pop up” frame, where the current web page remains and only part of the screen shows the new frame.

The internet allows each user to surf as desired. While one user may decide to surf the web according his or her own selections, another user might find different links to follow creating a different series of web pages.

The same surfing process would be desirable to follow to at least some extent in video segments and especially in movies. Many movies are now digitally encoded such as on DVD or downloaded from the web, or by means of satellite dish or cable transmission. Other methods of transmission may also be used. Given that the video is digitally encoded, it would therefore seem possible to associate links with various items in a particular video frame.

However, this is made particularly difficult for a number of reasons. First, videos, television programs, movies and the like are by their very nature moving images. In a typical video made or shown in the United States, the standard is NTSC which has thirty (30) frames per second (exactly 29.97 frames per second). At this rate, encoding an object in all frames of a video, if done manually, would be quite cumbersome. Even in only a ten (10) minute video segment, there are 600 seconds times 30 frames per second, i.e., 18,000 frames. Moreover, the shape of an item in one frame of the video may differ from the shape of an item in another frame of the video because the item may be moving. It can vary quite a bit over numerous frames of video. Accordingly, it is difficult to automate the process of defining an interactive item such that a user could “click on it”.

Further, it would be desirable for those who still watch videos or movies by means of conventional analog signals, e.g., video cassettes or conventional television signals, to enjoy the interactivity which is potentially achievable through use of a DVD or other digital signal playback device.

Currently, there appears to be a lack of interactive video (or TV or even music) where the video or music is the primary item being viewed. Particularly with respect to TV technology, the lack of sufficient computing-power in (or connected to) the primary television set; the lack of sufficient screen resolution on these set's screens, and a lack of sufficient (or any) bandwidth from some information storage device/system/network to these television sets creates the necessity of a modality of interacting with TV with a second screen, such as by concurrently running a PC with a monitor proximate the TV. This is quite cumbersome.

### SUMMARY OF THE INVENTION

In one embodiment of the present invention, tracking of a selected object in a video image is achieved. The steps are generally as follows:

1) Preprocess a video clip and determine “scene breaks” so that the system will not try to track across a scene change.

2) Train a neural-net for a particular object to be tracked within an initial marquee, e.g., a rectangular marquee, and use data derived from image data for a particular pixel (or pixels) within the object's image.

3) Identify the actual shape of the object inside of the marquee.

4) The object's shape is bounded by a new marquee (upper-left, lower-right) that encompasses the whole shape, and just the shape (where the initial marquee might have been smaller or larger).

5) Track forward (or backward) through the video's frames in the same scene to identify the shape-movement and generation of the next marquee.

First, an initial scene in the video is identified, then its first frame is displayed. The user selects the item(s) or object(s) to track. The system and method in accordance with one embodiment of the invention detects the beginning of a scene by processing data from scan lines to obtain energy values, and comparing those values to the data from a previous scan line.

After identifying the scene changes and user identification of the object(s) to track, the user selects a point inside the object. The system stores or determines and stores the data for that point or pixel, including Y U V data and cosine hue, sin hue and intensity.

The tracking process inputs include an image signal that is part of a video-sequence of images. The system displays the image, and the user selects upper-left and lower-right coordinates or upper-right and lower-left (or other coordinates) sufficient to create an initial bounding rectangle (a “marquee”) that surrounds all, most of or at least part of the initial selected object's image. The user selects a point inside the image, and an “object color” for that pixel of the image signal is stored (and may be displayed for the user's benefit). The pixel data is then used by the system to outline the object generally looking for pixels that are the same as or close to the selected color and in particular using preferably six parameters from or derived from the image signal for that pixel, including Y U V data and cosine hue, sin hue and intensity.

The six parameters are used to train a neural net to find points within and outside the target object. In a preferred embodiment, the training parameters may be adjusted for the neural-net to keep the output marquee from moving on every single frame (unless necessary) to minimize file size. The marquee file is preferably an XML file. The training parameters may also be adjusted to account for a reasonable amount of color variation in the object. The outline of the previous frame, and the neural net, are then used in the processing of the “next” frame in the sequence.

In a more preferred embodiment, scene breaks are identified by taking a number of scan lines, preferably a plurality and most preferably four scan lines from each frame, and performing a Fast Fourier Transform (FFT) on data from their image signal, and comparing the result with the FFT output from the previous frame. If the results are different by more than a threshold, then it is determined that there has been a scene change. This method of scene-change detection may optionally be enhanced by adding a step to handle a fade-transition. Taking a running-average of the FFT results over a number of frames, e.g., two, five, seven or other number, will help to identify scene changes where fade is used to transition. It should be noted that the word “scene” as used herein is intended to correspond to how scene is used in the video and movie industries. However, there may be situations where the system determines that there is a scene change prior to the actual scene change. This situation is generally not a problem for the system. It merely means that the user will have to re-select the same objects as selected in the previous scene.

The scan line or lines selected for the scene change determination are preferably near or at the horizontal middle of the screen, however in principal scan lines may be selected from other portions of the screen as well. The color scheme, R G B or Y U V (or Y in the Y U V or G in the R G B, or other color in these color groups, or all three colors, or other combinations) may be selected. Preferably, all three R G B components are used. While the FFT is preferred, other time/space de-correlation functions may be used, e.g., DCT (Discrete Cosine Transform), DFT (Discrete Fourier Transform), or even KLT (Karhunen-Loeve Transform).

Once the input video frames are segmented into scenes, objects can be picked-out by an operator using the graphical user interface (GUI) of the embedding system. The object is surrounded by a rectangular (or other desired geometric shape, though rectangular is preferred) initial marquee and the system will then track the object throughout the scene using the neural net and the outline data.

An initial box or marquee is taken with a range of hue and intensity having a variation of color to generate a training set of 30 candidate points (pixels). From the user interface, the initial frame from the video clip (scene), and the training points that are randomly extracted from within the marquee, and 120 non-candidate points that are randomly chosen from the whole frame. Accordingly, the initial marquee should preferably not have any points that are outside the desired object.

From each of the 30 candidate pixels (within the specified range of color from within the initial marquee) and the 120 non-candidate pixels, the system extracts six (6) color-related quantities preferably of eight (8) bits each. These quantities are computed from either the RGB value of the training pixel under consideration or the Y U V value of that same pixel (depending on the color space of the input video). The input features/values used in the training of the neural net (both candidate pixels and non-candidate pixels) are:

Y—Luminance in the Y U V color space

U—“blue-Y” “color” of the pixel in the Y U V color space

V—“red-Y” “color” in the Y U V color space

Sin (hue)—trigonometric sine of the pixel's hue in the HSV color space

Cos (hue)—trigonometric cosine of the pixel's hue in the HSV color space

Intensity—absolute intensity of the pixel in HSV color space

Y U V and Intensity have eight (8) bit precision. Since R,G,B are eight (8) bit precision, the hue extracted should have 24 bit resolution. The inputs to the neural net are all normalized from 0.0 to 1.0. The sines and cosines are normalized as (1.0+Cos(hue))/2.0 and (1.0+Sin(hue))/2.0. Redundant information is not a problem in neural nets. Biological systems appear to utilize redundant information systems. Use of the sin(hue) and cos(hue) variable is the preferred way of numerically utilizing the cyclic variable hue (0-2pi).

The neural net is preferably a three-layer arrangement with six (6) input-layer neurons (the six input parameters), six (6) hidden-layer neurons and one (1) output-layer neuron (part of object/not part of object).

The neural net is trained using back propagation with an output neuron value of 0.90 from the 30 candidate pixels and an output value of 0.10 from the 120 non-candidate pixels. The transform of functions used in training are the Sigmoid function. Essentially, the Sigmoid function is a Hyperbolic Tangent function on a shifted and scaled input, but with different training convergences e.g. (Tan H (x)+1)/2=Sigmoid (x). The Generalized Delta Rule Back Propagation method used to train the neural net is based on the work of Rumelhart, Hinton and Williams (E.g., “The meta-generalized delta rule: A new algorithm for learning in connectionist networks”, D. E. Rumelhart, G. E. Hinton and R. J. Williams, in D. E. Rumelhart and J. L. McClelland eds., Parallel Distibuted Processing: Explorations in the Microstructures of Cognition, Vol. I: Foundations, pp. 318-362, MIT Press, Cambridge, Mass. (1986).

Once the cumulative output error for all 150 training pixels drops below a preset maximum error level, the neural net for this object, in this scene has been trained. Once the neural net is trained, the entire set of pixels inside of the initial marquee is processed in the neural net. The neural net outputs a “one” for a candidate pixel or a “zero” for a non-candidate pixel, within the marquee region. The rest of the image is assigned a value of “zero.”

The center of mass of all the “one” pixels is also determined. After processing the entire frame, the pixels that are adjacent and have a value of “one” (and so determined to be “part of the object”) are grouped. A morphological “closing” filter is used to fill-in any holes (closing is morphological dilation followed by erosion). The input to the 2D shape search is a binary image (zero or one). In this process, a 2D version of a 3D marching cubes algorithm is preferably used. 3D marching cubes are found, e.g., at Kitware, Inc., www.public.kitware.com/VTK/. The Visualization ToolKit (VTK) is a software system for 3D computer graphics, image processing, and visualization in C++. See also, The Visualization Toolkit An Object-Oriented Approach To 3D Graphics, 3rd Edition, Will Schroeder, Ken Martin, Bill Lorensen, VTK version 4.2, ISBN 1-930934-07-6, and The Visualization Toolkit User's Guide, Kitware, Inc., ISBN 1-930934-08-4, both published by Kitware, Inc.

Once the image is “closed” a 2D variant of the 3D “marching cubes” algorithm is used to find the outside of the shape. This works by dividing the known space into squares of other polygons. Then the algorithm tests the corners of each square to see if it is inside the object or not. If not the square is replaced by a set of smaller polygons and the algorithm is repeated until no further division of the polygons is possible.

A 64-field visual field model is used to describe the shape with 64 radial extents from the previously computed center-of-mass. The procedure determines the largest radius from the center of mass for each of the 64 fields. These radii in turn define the shape of the object. The resulting information on the shape is in polar form.

The 64-field model is adapted from the visual orientation model of Hubel and Weisel. A reference to their work can be found at http://www.rybak-et-al.net/iod.html. The radial information used is simply the largest radius found from the center of mass for each field. Hubel and Weisel established that the visual system has 12 preferential orientations. The preferred embodiment choice of 64 arises from the fact that it is a power of two. This facilitates use of an FFT (Fast Fourier Transforms) in finding the Fourier descriptors of the shape. See Zain, C. T. and R. Z. Roskies, “Fourier Descriptors for Plane Closed Curves,” IEEE Transactions on Computers, Vol. C-21, pp. 269-281, March 1972. Fourier descriptors are the preferred way for manipulating the shape of the object.

The upper-left (UL) and lower-right (LR) pixel coordinates from this shape are output from the system as a “new” marquee definition. The UL y coordinate defines the minimum y extent of the object. The LR x coordinate defines the maximum x extent of the object. The LR y coordinate defines the maximum y extent of the object. This marquee is now “fitted” to the selected object.

The system returns the weights from the neural net, the new marquee and other parameters and the center-of-mass of the object. The new marquee is preferably larger, e.g., two units or pixels larger in x and y then the box determined by the UL and LR box coordinates. This is to allow for possible motion of the object in a succeeding frame. These values are used as the new starting point for the next iteration of the system on the next frame (or previous frame when processing backward through the video frames).

In another embodiment of the invention, a system for playing embedded links associated with the object or objects identified and tracked by the embedding system, to view the associated data, e.g., a web page, other video clips, or other information, in a preferred embodiment, includes a computer having a CPU, a storage device, a monitor, a keyboard and mouse. Video program data may be played on the monitor from a DVD-ROM drive in the CPU, from the internet, from a remote database, or from another storage device. When the user's mouse is over any object that has an embedded link, the mouse may, according to a preferred embodiment, change shape, size or color, or otherwise indicate that the object contains a link. If the user clicks on the mouse, the links associated with the object are displayed, and the user may select a link. The auxiliary or secondary data, e.g., web page, new video clip, advertisement, sponsor information, etc., may be displayed on the entire monitor screen, or just a portion thereof, or a split-screen view. The primary data (original video viewed by the user) may preferably be paused for the user to return to when done with the secondary data. Alternatively or in addition thereto, the player system may store or “bank” the user's selected links (into organized “accounts”) for access later when the video is over.

In another embodiment, the interactive video may be displayed on a television, via a DVD player, cable, satellite, or other signal transmission method, and simultaneously an adapter unit may allow a user to interact with the video, either by also playing the video on the adapter unit, or by operating similar to web television. The adapter unit can be replaced by a computer, which contains the same kind of programming, or which also receives the video signals.

### BRIEF DESCRIPTION OF THE DRAWINGS

FIG. 1 is a schematic view of a first frame of video e.g. of a scene;

FIG. 2 shows a frame subsequent to the frame of FIG. 1 (e.g., the next frame), showing motion of the items in the frame relative to the frame of FIG. 1;

FIG. 3 is a schematic diagram of hardware for carrying out the video tracking and/or video playing in accordance with one embodiment of the invention;

FIG. 4 is a flow chart of a sequence of steps carried out in accordance with one embodiment of the invention to find a scene change;

FIG. 5 is a schematic diagram for explaining a video object tracking operation in accordance with one embodiment of the invention;

FIG. 6 is a view of the same frame of FIG. 1, but with a first selected color point and a box around an item containing that point for purposes of tracking the item in accordance with one embodiment of the invention;

FIG. 7 is a view of the frame of FIG. 6, but with a center of mass point identified and an outline of the item generated to function as a link to data in accordance with one embodiment of the invention;

FIG. 8 is a view of the frame of FIG. 2 but with a center of mass point identified and an outline of the item generated to function as a link to data in accordance with one embodiment of the invention;

FIG. 9 is a chart of linking data (metadata) to be accessed as desired by a viewer of a video marked in accordance with one embodiment of the invention, to link secondary data to video program (primary) data in accordance with another aspect of the invention;

FIG. 10 is a chart of energy values for each frame and line number for use and explanation of the new scene locating routine in accordance with one embodiment of the invention;

FIG. 11 is a flow chart of a sequence of steps carried out to determine an outline of a selected item in a video frame in accordance with one embodiment of the invention to find a scene change;

FIG. 12 is a flow chart of a sequence of steps carried out to enable a user to select an item in a video frame to link to various other data in accordance with one embodiment of the invention;

FIG. 13 is a flow chart of a sequence of steps carried out in randomly selecting points in a video frame inside and outside a desired item in the frame of FIG. 12 in accordance with one embodiment of the invention;

FIG. 14 is a flow chart of a sequence of steps carried out in tracking and outlining a selected item in the second frame as the item has moved in the second frame with reference to the first frame in accordance with one embodiment of the invention;

FIG. 15 is a schematic diagram for explaining connections of a neural net in accordance with one embodiment of the invention;

FIG. 16 is a chart of neural net weights determined in accordance with another aspect of the invention;

FIG. 17 is a schematic diagram of four raster lines having data therein and for use in accordance with the present invention;

FIG. 18 is a schematic diagram of operations carried out for play back of the interactive video in accordance with the present invention;

FIG. 19 is a schematic view of a screen showing playback operations where a viewer has clicked on a hot object on the video;

FIG. 20 is a schematic view of information displayed on a screen when the user selects one of the links shown in FIG. 19;

FIG. 21 is a schematic view of an embodiment of the player system where the user has a television for displaying program (primary) data; and

FIG. 22 is another schematic diagram of operations carried out for play back of the interactive video in accordance with the present invention.

### DESCRIPTION OF THE PREFERRED EMBODIMENT(S)

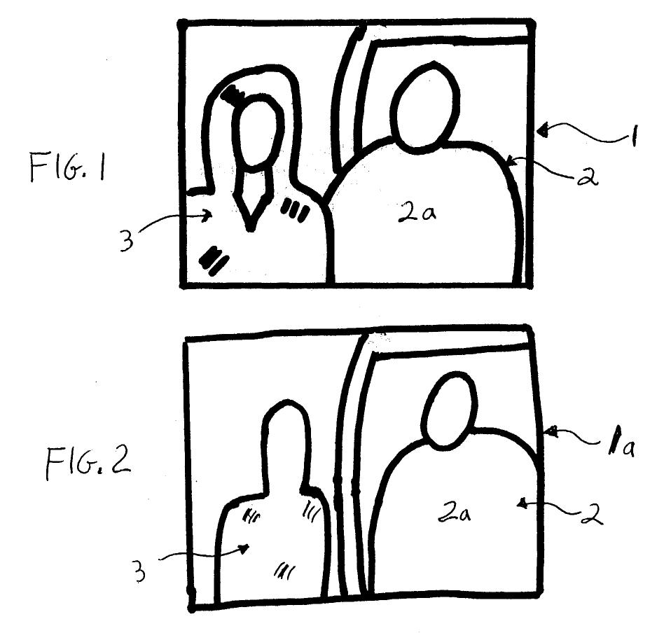

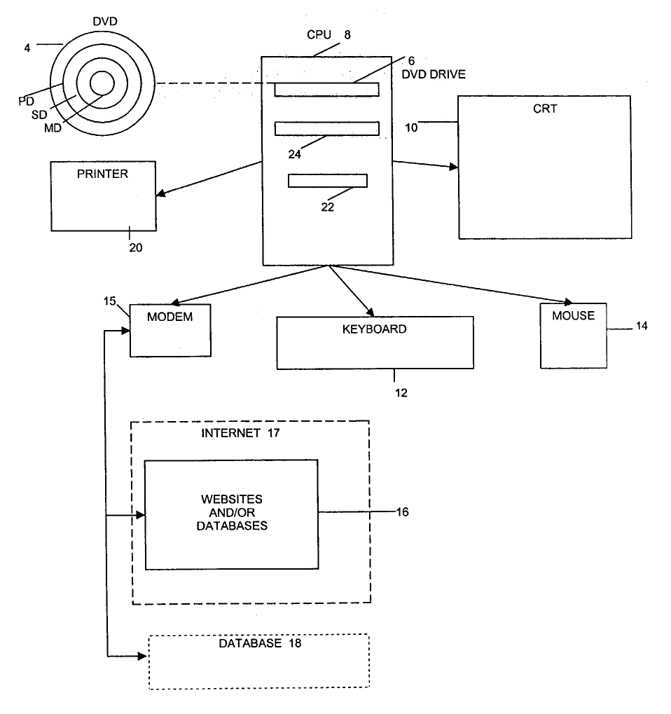

As shown in FIG. 1, a video image 1 may change over a series of frames into a video image 1a where two characters 2, 3 have moved to their left. If the image of a shirt 2a on character 2 is to be made a link (“hot” or “clickable”), then the video frame of FIG. 1 having the shirt shown in a first position must be processed and the next video frame shown in FIG. 2 would have to be separately processed. However, in accordance with the invention as described herein, all that is needed for any particular scene is to make the item hot in one scene or identify the item in one frame, and the system and method of the invention will identify the item in other frames, preferably other frames within the same scene and preferably all other frames within the same scene. Most preferably, in the system and method of the invention, a frame or the first or last frame of each scene is identified, and then each item selected by a user is made hot or identified for being made hot. Then, the system and method identifies the same item in each subsequent (and/or previous) frame in the scene.

After all desired items are made hot in the video movie clip or other series of images, i.e., “primary data” (PD), metadata (MD), i.e., links or hyperlinks to “auxiliary data” (AD) or secondary data (SD), e.g., web sites, other video segments, or other data, is stored in association with the object(s). AD may include information about an actor or actress, information about the item itself such as a clothing designer, a web site where the clothing may be purchased, or other information related to the hot item may be stored or sent with the original video (PD), or it may be separately stored or sent, accessed in real time, or accessed at a future time, e.g., by bookmark by a user.

A video may be considered to be any set of sequenced images, where the images move. Generally, a typical video will have at least 24 or 30 frames per second, and that is the preferred embodiment, but video could move slower, e.g., at 12 frames per second, close to the cutoff point of where the human eye considers the images as one moving image rather than a series of pictures. Video could move even slower, e.g., one frame per second. Normally, though not necessarily required, aside from interactivity as disclosed herein, a video would be intended to be played back and have utility if played back and viewed without any interactivity.

Encoding or embedding of the hot items will now be described. The first step in the embedding process is to identify the different scenes if any in the video or program data being processed.

A hardware system suitable for encoding or embedding and processing the video in accordance with the invention is shown in FIG. 3. The Primary Data is stored on a track on a machine readable recording device such as a DVD, CD Rom or other recording medium. The DVD is placed in a DVD drive 6 of a CPU 8. The hardware system has a monitor 10 such as CRT, a keyboard 12, a mouse 14, and may also have other devices associated therewith. For example, there may be a modem 15 such as a DSL modem, cable modem or otherwise for connecting to websites and/or databases 16 on the internet 17, or a database 18 separate from the internet 17.

The computer may also have a printer 20. The CPU may also contain other drives such as a disk drive 22 and a second CD or DVD drive 24.

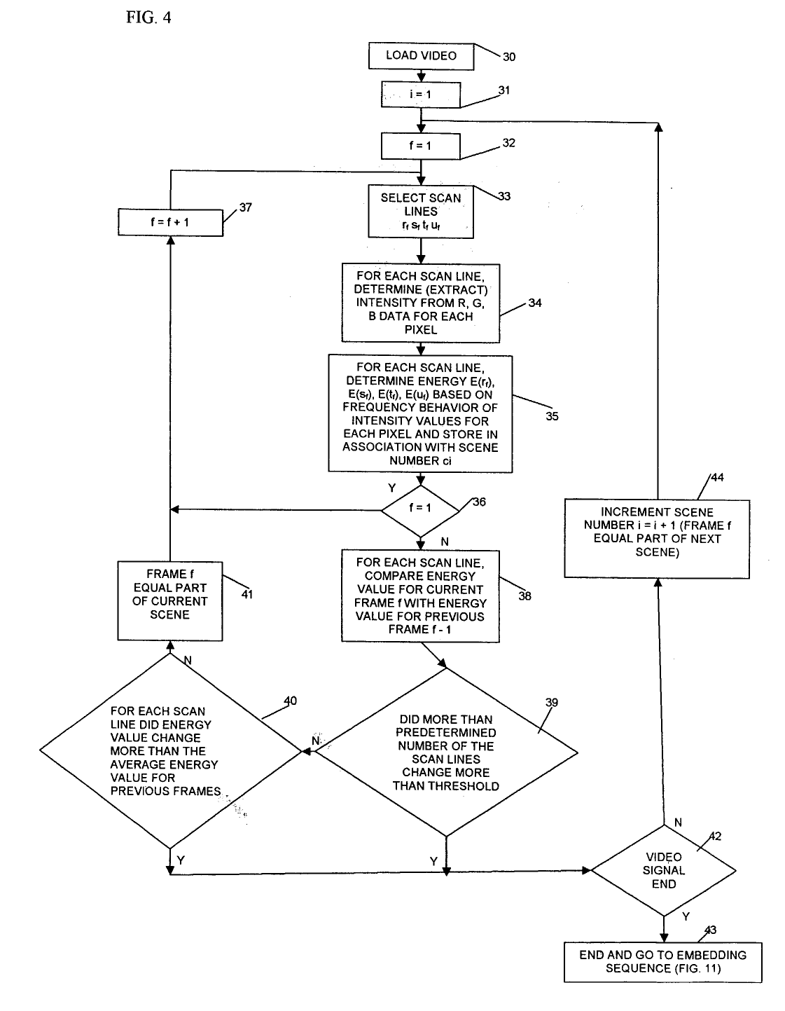

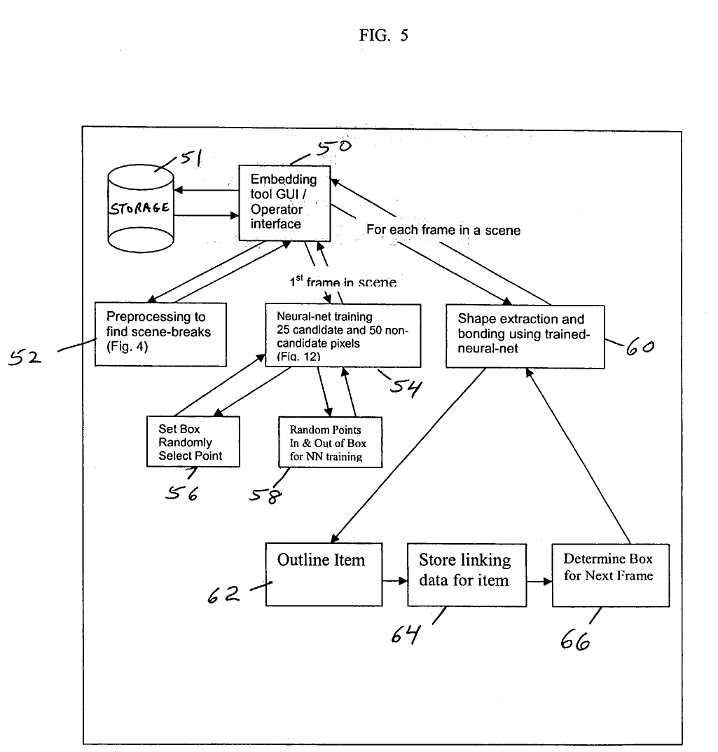

The process of FIG. 4 identifies the first frame in a scene. At step 30, video is loaded. At step 31, the scene number i is set equal to 1. At step 33 the embedding software selects a sample scan line or sample scan lines, e.g., four scan lines r_{f}, s_{f}, t_{f}, u_{f}. The scan lines are shown schematically in FIG. 17. In step 34, for each scan line, the system extracts or determines intensity from R G B signals in the video signal for each pixel. In step 35, the software determines, for each scan line, an energy value based on frequency behavior of the intensity values for each pixel and stores these energies in association with a scene number. For example, energy values Er_{f}, Es_{f}, Et_{f}, Eu_{f} are derived from the red, green and blue signal data for each pixel.

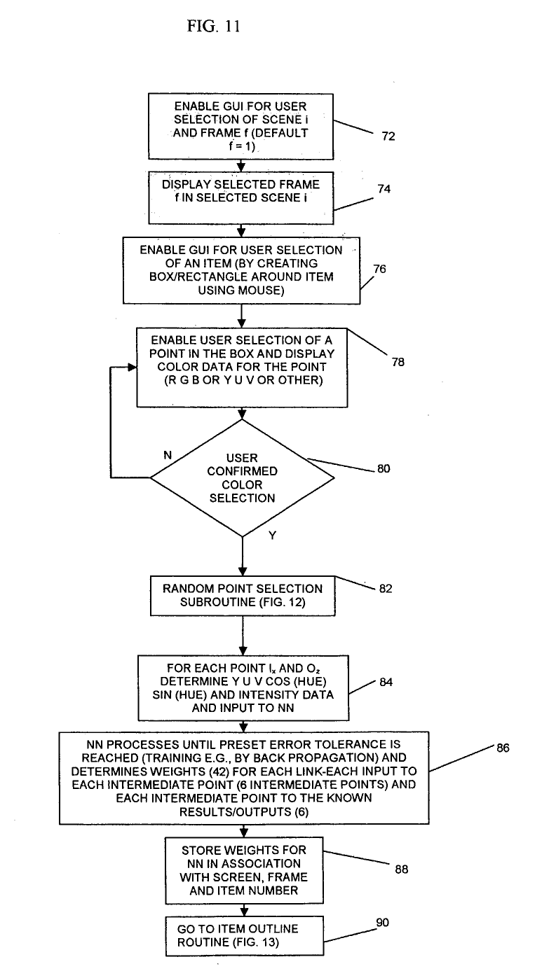

The energy values are then stored in association with scene, frame and line numbers, e.g., as shown in a representative lookup table of FIG. 10. At step 36, the system asks if this is the first frame (or last frame if processing backwards). If the answer is yes, then at step 37 the system increments the frame by one (or decreases the frame number by one for reverse processing). It is possible to encode, for example, every other frame, or even every twelfth frame or even only one frame per second, to simplify processing, as a user may not be able to detect the difference. The system would simply, for playback, look for the closest frame having a hotspot, or it would duplicate for each frame the information from the prior frame, until the next encoded frame, or until halfway until the next encoded frame. However, it still might be preferred to detect changes from frame to frame or at least every other frame.

Next, the system returns to the loop of steps 33 to 36 to determine the energy values for the next frame. At step 36, and the software will indicate that the frame number is not one. The system will continue to step 38. In this step, each scan line has its energy values compared with the energy used for that scan line from the previous frame. At step 39, the system asks whether or not a predetermined number of the energy values have changed more than a given threshold. A preferred threshold amount and a preset number of the energy values changing to indicate a scene change is three out of four. However, the threshold and the predetermined amount may vary, particularly if the system is to over detect scene changes rather than under detect them as over detection is less of a problem than under detection. The threshold amount and preset number of energy values may also vary if the system is set to look at fewer or greater than four scan lines, if the scan lines are selected at locations other than at or near the center of the screen, or if selected pixels or parts of scan lines are used.

If more than the preset number of energy values have changed more than the threshold, the system asks if the video has ended (step 42) and if it has, the user can start the embedding sequence of FIG. 11. (Alternatively, the user could also start the embedding sequence after each scene change is detected.) If the video has not ended, the scene number i is incremented by one and the frame number f is stored as the first frame of this next scene in the storage, such as in the look up table of FIG. 10 for use later in the embedding sequence. If, at step 39, the system does not detect changes greater than the threshold for three out of four energy values, the system asks at step 40 if the energy values have changed more than a threshold from an average of past frames. The purpose of this step is to account for scene changes that occur by the technique commonly referred to as a fade out (and/or a fade in) transition. If, in this fade transition detection step, the system detects more than a threshold change in less than a preset number of the energy values (e.g., three out of four), the system will determine that the scene is the same (step 41) and will increment the frame number f (step 37), then return to the energy value determination steps 33, 34 and 35 for this next frame. In identifying a fade transition in step 40, the number of past frames selected, e.g., two, five, seven, or other amount to average, the type of average (preferably a running average), the threshold for an energy value change may be different from the numbers used in step 39, and may be varied depending upon the desire for over detection of scene changes.

The process of FIG. 4 is preferred for scene change detection, but other ways of determining a scene change may be used in the overall process of tracking an object or objects and embedding links and/or other data in association with tracked objects.

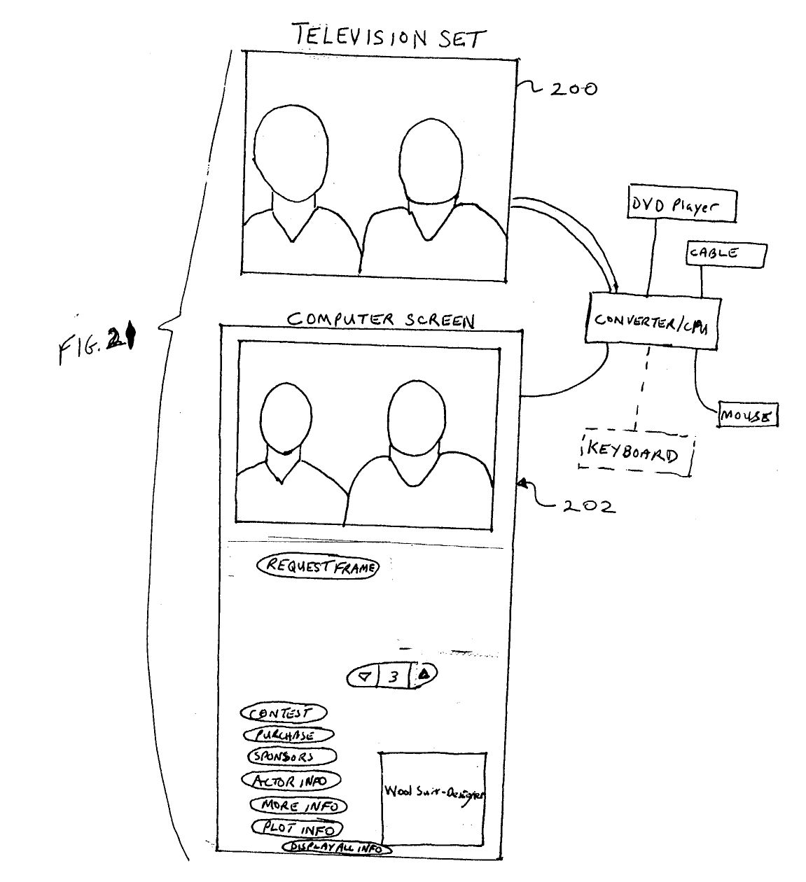

FIG. 5 is an overview of the inventive process of tracking an object or objects and embedding links and/or other data in association with tracked objects. The inventive system, preferably embodied so as to include software 50 has a graphical user interface (GUI), which may be shown on a monitor 10 (CRT or otherwise) and may be run on a computer system as shown in FIG. 3. Element 51 represents a storage device for the video file, which may be akin to that shown in FIG. 3, or in FIG. 20.

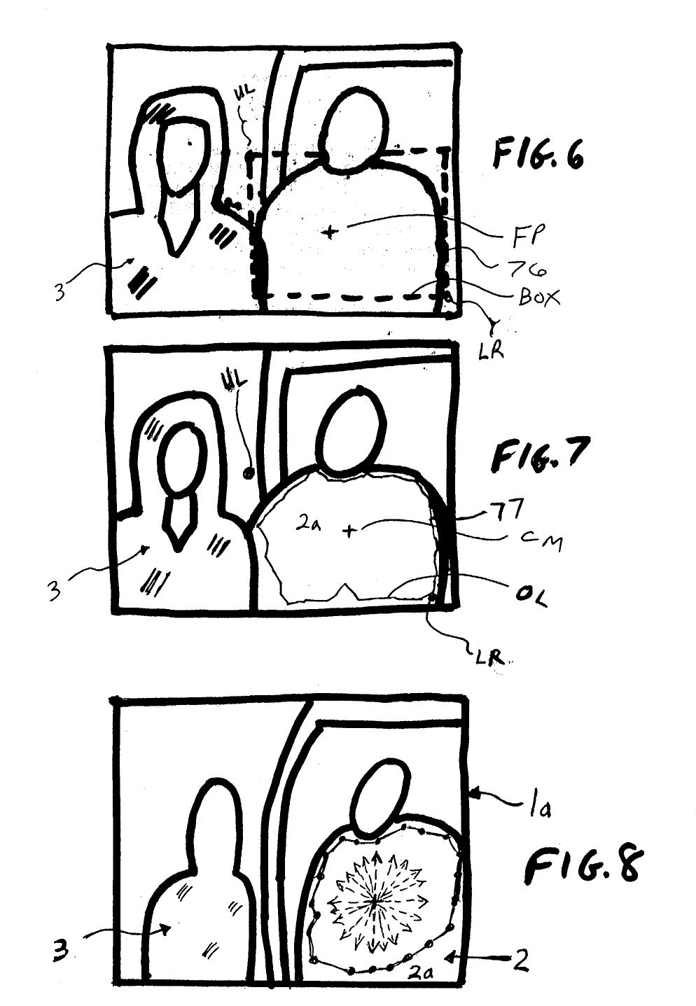

Once the first frame in a scene has been identified (step 52 and FIG. 4), the embedding routine or system may be used, as shown in FIG. 11. The user selects an item to track by clicking on the item (e.g., FP shown in FIG. 6), then the system identifies all points within the object and draws a box 76 around the object by finding points of similar parameters (step 56). The user may select the UL and LR coordinates for the system. At step 56, the software randomly selects points inside and outside the box, preferably 30 candidate pixels, and 120 non-candidate pixels. Neural net training is conducted as described elsewhere herein.

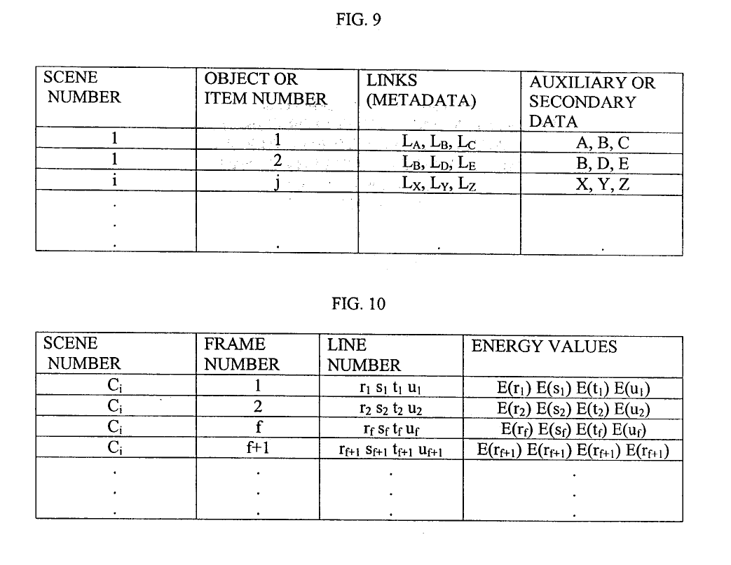

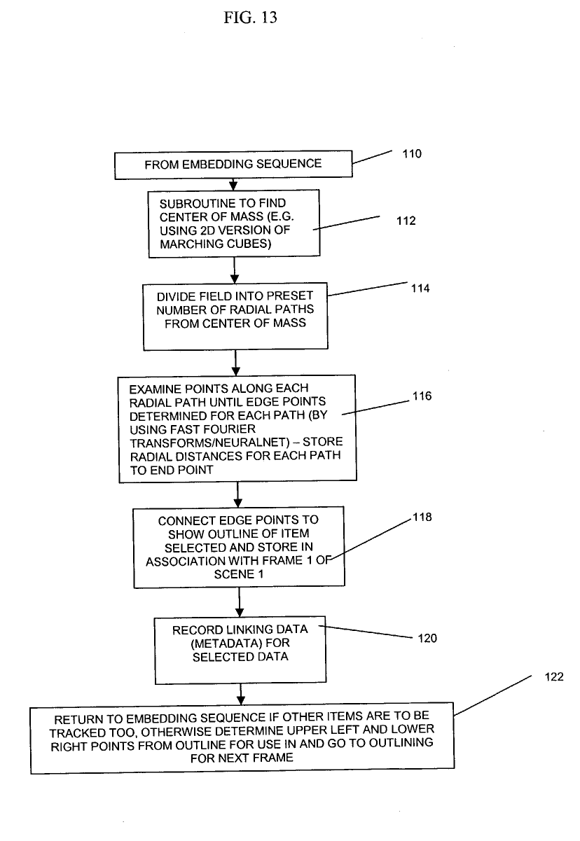

After neural net training the software has weights for the neural net so any pixel in the marquee can be analyzed as to whether it does or does not belong to the object. At steps 60, 62, and FIGS. 11 and 13, the trained neural net is used to generate an outline 77 of the object's shape. A center of mass (CM) is also determined and displayed. After the embedding sequence and, as shown in FIG. 13, step 62 shows outlining the item shown in more detail in FIG. 13. Step 64 shows recording any linking data (metadata) L_{A}, L_{B}, L_{C}, etc. to the desired auxiliary or secondary data, A, B, C, etc. for the item as shown in the look up Table of FIG. 9. This object, having a unique identification or item number for each scene, also has associated therewith the outline data for each frame. As explained elsewhere herein, once the item is clicked on during use, the menu of the links will be displayed in and the user may click on the link to display the associated secondary data.

At step 66, the box or rectangle for the next frame is determined. The shape extraction and bonding using a trained neural net occurs for each frame in each scene. It can be done for fewer than each frame as explained elsewhere herein, but the user may experience inconvenience at some point if too few frames are “bonded” (connected to a link).

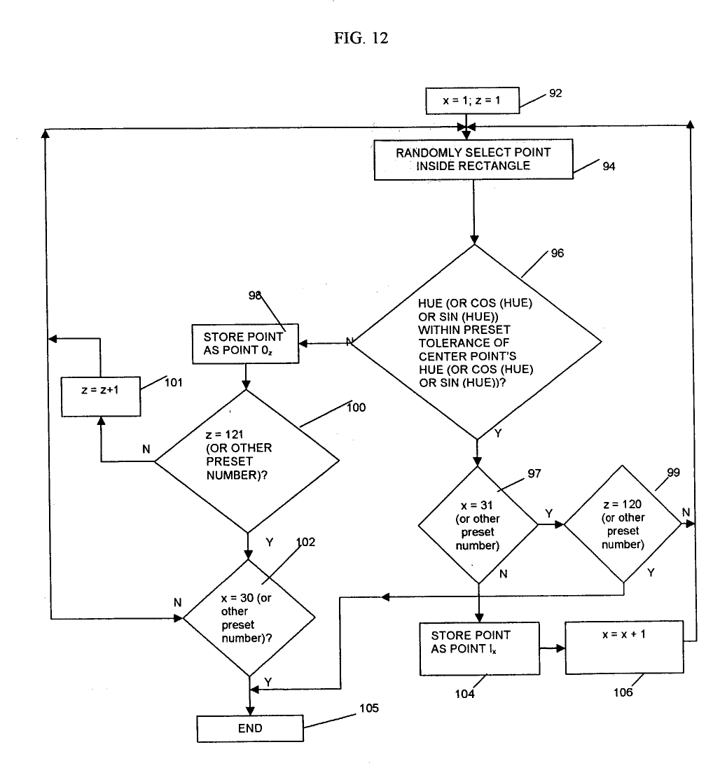

With reference to FIG. 11, the embedding sequence will be discussed in detail. At step 72 the system enables the GUI for user selection of a scene and frame. The default equals 1. In step 74, the selected frame f is displayed in a selected scene i. In step 76 the GUI is enabled for the user to select an item to make hot. The user preferably selects the item by creating a box or rectangle around the item and preferably using a mouse. In accordance with a preferred embodiment of invention, this process is simplified by the user clicking on an upper left-hand coordinate (UL) and a lower right-hand coordinate (LR), and the software forming a box or rectangle using those coordinates. The UL and LR are shown in FIGS. 6 and 7 for a selected frame, e.g., preferably the first frame in a scene. The user then selects a point or pixel FP anywhere inside the item or in the box. Color data concerning that point or pixel may be displayed by the GUI. The user may have an opportunity to confirm the color. The user's selection of this point occurs at step 78. The user confirms the color selection at step 80. If it is not confirmed, another point is selected. If it is confirmed, at step 80, the software then performs a random point selection subroutine at step 82 which is shown in FIG. 12. The user could select these points out but it is preferable to use random selection software to select points as it is faster. Some of the points will be inside the region of the target item and other points will be outside the region defined by this initial box. After the random point selection subroutine described below, at step 84, for each point 1× within the item and each point Oy outside the box, color data Y U V, cosine hue, sin hue and intensity are determined and input to the neural net. At step 86, the neural net processes until a preset error tolerance is reached, as elsewhere herein.

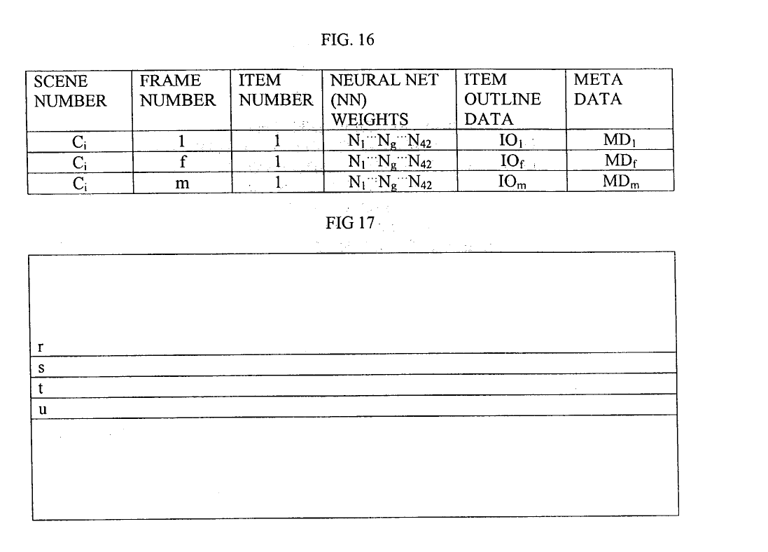

Training occurs by back propagation as is well-known in the art of neural nets. The neural net determines the weight factors, e.g. 42 factors for each link. The weights are then stored at step 88 in association with scene, frame and item number data, preferably in a table as shown in FIG. 16.

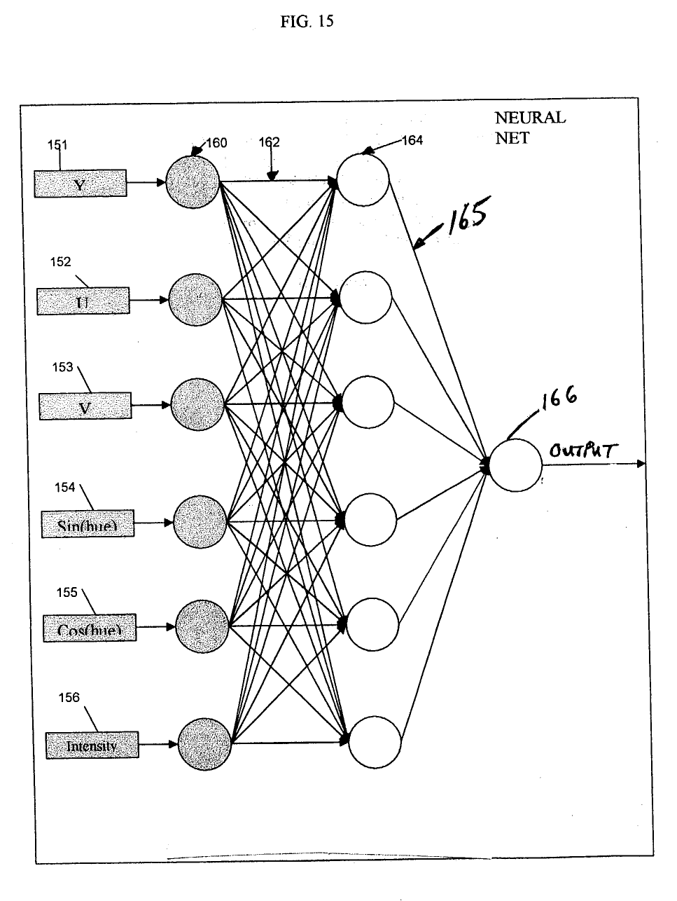

The neural net is preferably a two layer neural net, as shown in FIG. 15. The software goes to the item outline routine of FIG. 13, shown by step 90. In the random selection subroutine on FIG. 12 (from step 82 of FIG. 11), at step 92, the system sets x and z equal to one. At step 94, a point is randomly selected inside the rectangular box. At step 96, the software determines whether or not cosine hue (or sin hue or hue) is within a preset tolerance of the center points' hue, cosine or sin thereof. If these parameters are not within the preset tolerance, the point is designated as being outside the target, as shown by step 98. At step 100, the system looks for z being equal to 121 or other preset number e.g. 61 if 60 points inside the object are to be used instead of 120. The software determines whether or not that preset number is matched. If not, z is incremented by a one at step 101. Z randomly selects the next point inside the box at step 94. If z is equal to 121 or other preset number, then the system also checks to see if x is equal to 30 at step 102 (or other preset number such as 15). At step 105 the subroutine ends. If hue, sin hue or cosine hue are not within preset tolerance of the target points' corresponding value at step 98 the software stores the point as point O_{z} outside the object. If within the preset tolerance, then the system goes to step 97. If x equals 31 or other preset number at step 97, then at step 99 there is a comparison to see if z is equal to 120 or other preset number. If x is not equal to 31, then at step 104 the system stores this point as Iₓ and at step 106 increments x by one, then returns to random selection step 94. If x equals 31 but z does not equal 120, the system will continue to randomly select points. Otherwise, the routine ends at step 105.

The neural net weights in the table of FIG. 16 are stored in conjunction with the scene number, frame number and item number. The item outline IO data and metadata may also be stored in the same table in association with the scene, frame and item number. In the item outline routine of FIG. 13, at step 110, the embedding sequence is initiated. At step 112 there is a subroutine to find the center of mass of the item. The center of mass and item outline are found by using a two dimensional version of marching cubes.

At step 114, the field is divided into a preset number of radial directions from the center of mass CM (e.g., 64). The number 64 is selected because it is a multiple of two and is sufficiently large to provide adequate resolution for the target outline. The multiple of two facilitates the use of a Fast Fourier Transforms (FFT). The radial distances in 64 directions are determined using marching cubes. These radial distances are to the points defining the edges of the target item. These edge points are determined for each path by using FFT and the neural net. The radial distances are stored for each path to its edge from the center of mass. At step 118, the system connects the edges of the points to show an outline of the item selected and stores that data in association with frame one of scene one. Metadata for selected data is recorded by the user at step 120. The system returns to the embedding sequence if other items are to be tracked also, at step 122. Otherwise, the software determines the upper left and lower right points.

In FIG. 7, the center of mass CM and the outline of the target 77 are shown. Also shown is the upper right and lower left bracket points, taken from the previous frame. FIG. 8 shows the radial directions. For simplicity, not all 64 are illustrated, although 64 is a preferred embodiment. Many more or many fewer radial directions may be used.

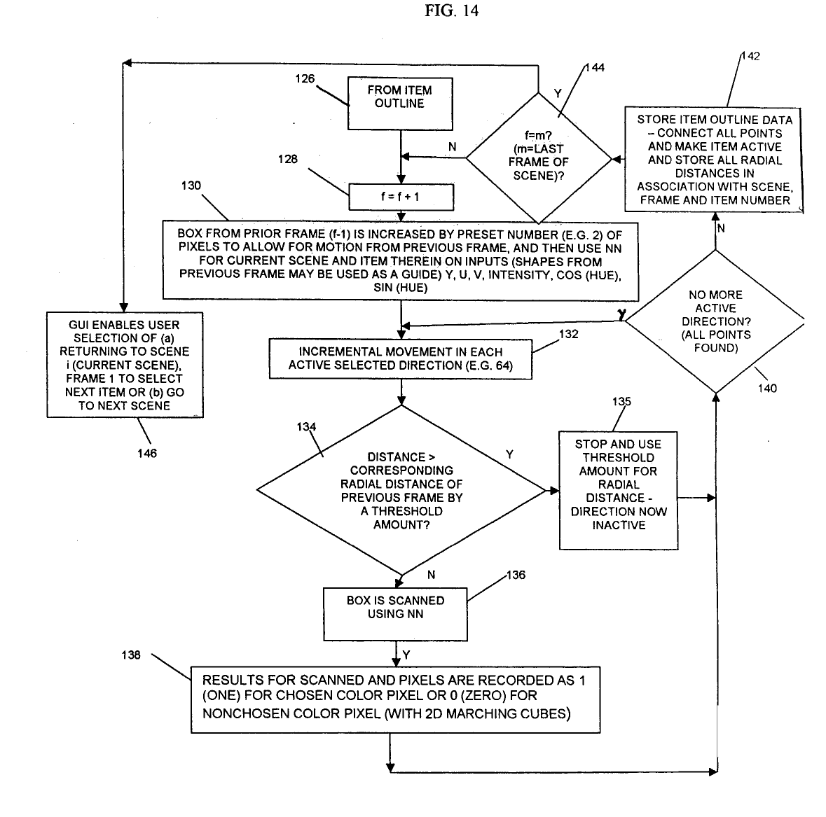

In FIG. 14, the system determines the box to use in the next frame to look for the object. The subroutine is initiated from the item and outline of FIG. 13. At step 128, the frame number is incremented by one. At step 130, the box from the prior frame is increased by a preset number, for example, two pixels, to allow for motion from the previous frame. The box and/or shapes from the previous frame are also used as a guide or limit, e.g., by increasing the box size by no more than two units or pixels. The Y U V data, intensity, hue, sin hue and cos hue are used as inputs to the neural net (NN). At step 132, there is an incremental movement in each active (each point not yet found) selected direction. At step 134, the software determines whether the distance is greater than the corresponding radial distance of the previous frame by a threshold amount. If the distance does not exceed the radial distance of the previous frame by a threshold amount, the box is scanned using the neural network at step 136.

In the next step 138, the results for scanned pixels are recorded as a “one” for a chosen color pixel. The 2D marching cubes are used, as explained elsewhere, to find the radial extents of the object from the center of mass, as explained above. At step 140, the software asks if there are any more active directions or have all the endpoints been found. If all endpoints have been found the software returns to step 132 to use incremental movement in each active selected direction. At step 140 if there are no more active directions (all edges have been found), the item outline data is stored, and all the points are connected to outline the item at step 142. At step 144, the software asks whether the frame number is equal to m where m is the last frame or scene. If yes, the software enables a user by means of the GUI to return to this outline routine, so that another item may then be framed (step 146). If f is not equal to m, then the software returns to incrementing the frame number and determining more outlined points.

In FIG. 15, the diagram shows six inputs 151 to 153 and 154 to 156. The sine, cosine and intensity are designated numbers 154 through 156, respectively, while Y U V are designated 151 to 153, respectively. Each of these inputs is fed to a single first layer 160 of the neural net. The lines in FIG. 15 represent connections 162 of the first set to the second set. These lines represent the weights that have been determined during the neural net training described above. The connections 162 to connect up the first layer 160 with the second layer 164 add up to 36 paths. Element 166 is the desired output. There are six connections 165, having six weights, to the output 166. Accordingly, this preferred neural net has two layers of weights and processing, totaling 42 paths/weights. Fewer or greater paths and weights may be used.

The output of the embedding sequence is stored, e.g., in a Table in a memory device, e.g., a DVD, CD-ROM, hard drive, etc. Preferably, the output is an XML file, though other files may be preferred depending on the hardware being used, the hardware for playing the video, and other constraints which will be evident to those of ordinary skill in the art. The output file contains the item or object number, the scene number, the frame number and/or time code, or other temporal indication of its location from a reference, e.g., the beginning of a scene or the beginning of the video, the object's images outline data (to define the place on one's screen for a user to click on) and the link data (metadata) as shown in the table in FIG. 16. The neural net weights are not necessary in the final output file. In order to play the video so it is “interactive” i.e., clickable on selected object images with the result that the user may link to desired secondary data, e.g., a web page, other video, and/or database information, the item outline and time data (frame, scene and frame, time code, or other temporal reference data) are all that are needed, along with the linking data. However, it is also possible to add linking data, and/or modify it, subsequent to initially determining the object location data (item outline and time data).

Accordingly, the embedding sequence discussed above provides a system to identify the objects in each frame in a scene, so that they may then be linked to one or more sets of data, e.g., one or more web pages, one or more database files, one or more videos, etc. This enables Interactive TV (ITV) or video. Three data types and several methods of interacting therewith exist. The inventive “player system” allows the viewer, while watching a video program, to identify objects seen in the program and “click on them”, truly interacting with the video content. This action can result in delivering the requested information to the viewer in real-time or “time shifted” at the viewer's discretion. The action may cause the delivery of an advertisement, a page of information about a product, factual information supporting what is seen in the program or a purchase opportunity, etc. This invention may be embodied in various ways for ITV such as set-top boxes, web enabled DVD players, PVRs (personal video recorders/players), IP television or streaming to a PC. The invention also may be embodied where two screens are used, including synchronous delivery of information to PDA's web pads, home networks connected through a variety of next generation connected devices. In this “two screen world” a viewer, while logged onto the Internet, can request images seen on the television and display the requested image in a browser window on their connected device.

In the player system, the primary data (PD) is the actual video, TV program, entertainment or educational data. This is most often thought of as “Video” or TV, but it can in fact be any primary presentation of information, including audio (radio), music and web pages where in the form of a sequence of moving frames (video).

The Auxiliary Data (AD) or Secondary Data (SD) is the supplementary data or information, which can be of the same form as the PD (video, TV, music), or data of a different form, e.g., say web pages, or audio commentary. SD is typically supplemental to the PD but it may become the PD. SD is called up via the linking data or metadata (MD). MD links the “clickable” spots on the PD.

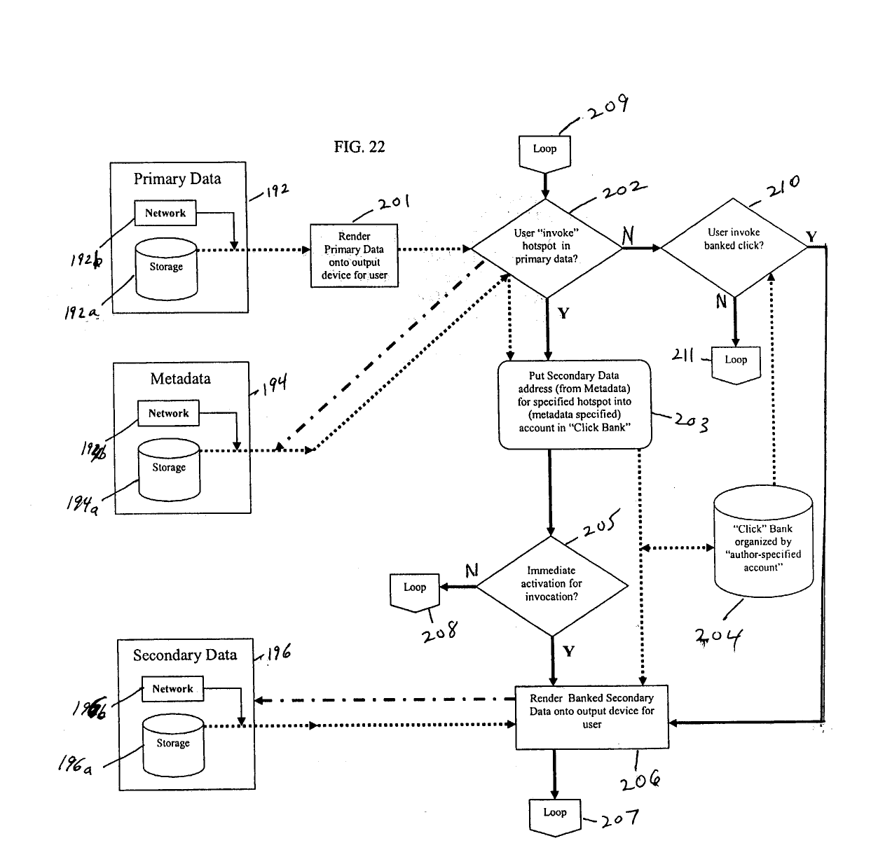

The hardware system of FIG. 3 or a system comparable thereto may be used to play the video in an interactive mode in accordance with a preferred embodiment of the invention. In one embodiment, the PD, MD and SD are all stored in storage media or source 192, 194, and 196 respectively, which may be a physical media 192a, 194a, 196a at the user's computer or from a network storage 192b, 194b, 196b (FIG. 22) such as from a LAN, or a connection to the internet, or a connection to a database, e.g., via modem (whether cable, wireless, satellite, etc.). The PD, MD and SD may be on the same storage media, separate storage media, or any two of these three data types may be on one storage media and the remaining data type is on another storage media. The same is true of the network. All three data types may come from the same network connection, or they may come from separate connections, or two may come from the same connection and one type from another connection. It is even possible to have part of one data type stored in one place, and another part of the same data type stored in another place.

For example, the storage media 192a, 194a, 196a may be various tracks, preferably separate tracks, on the same DVD-Rom 4 (FIG. 3) which the user inserts into DVD drive 6. They may also be on different DVDs or CDs or other storage or source devices.

To begin play, as shown in FIG. 22, the software player system plays the PD of the DVD preferably in a conventional manner at step 201 and preferably until a user decides to click on a desired object image in the video. At step 202, when the user “clicks on” or otherwise selects an object's image, the player system determines whether the user has invoked a proper (“hot”) image by comparing the mouse or pointer location e.g., on the computer screen and the frame and/or time code of the video being displayed with the stored MD's object location and time code and/or frame number. If the user is in the immediate selection mode, at step 203 the system will store the MD sent from MD source 194 at the user's request (from step 202) associated with that object (if any), and the address of the SD contained in the MD is sent to a storage (bank) 204. The bank may have the address data organized into “accounts”, e.g., folders with selected types of information, such as “actors,” “purchases”, or other folders generated by the user and/or by the system.

The MD need not be stored as a whole. It is sufficient to store the address data of the SD, and other data associated with the MD such as the object's outline and frame or time code need not be stored, though it can be.

At step 205, the system asks whether it is in play or storage mode, i.e., should it play or show the SD now (step 206 where the SD may be shown on the output device, e.g., a computer monitor or TV screen), or if it should simply continue with playing the PD and thus return via the “loop” (at steps 208, 209) to step 202 where the PD is playing and the user may click. If the system is going to show the SD at step 206, the information for the SD is requested (dot and dash line) from the SD storage 196 and sent back (dotted line) for playing on the output device. The user may return, when done with any SD, to step 202 where the PD will resume playing. The user may again click on an object.

At step 202, if the user was watching the PD (e.g., a TV program) on television, and thus could not click on the TV screen or otherwise did not have a way to access the SD in real time, or if the user simply wanted to bank the clicks even though the user could have accessed the SD at the time the clicks were banked, and now the user is watching or accessing the SD using a computer, the system will ask if the user wants to access any banked clicks (step 210). If the user does not want to invoke a banked click, the system will return via steps 211 and 209 to step 202. Thus, the SD can be viewed in real time by interrupting the PD video (or music/sound broadcast) flow, or it can be banked for later access (time shifted).

The SD (called up via interaction with the MD) can be synchronous to the PD. For example, a click on a stock ticker can bring up the financial information (SD) via MD for the company shown on the ticker. Though synchronous may denote “to be together in time,” synchronous SD can be time-shifted from the PD—what matters is that the SD has a synchronous temporal relationship to the PD at the time of the interaction, regardless of when the interaction is actually realized (time-shifted). This can be thought of as clicking on an actor “for more information” and having the actor's biography comes up after the movie is over. The SD was synchronous to the PD at the time of the interaction i.e. the click, but the display was time-shifted.

The SD can be displayed (if video) on the same screen as the PD, displacing the PD, or the SD can be displayed in a window on the screen of the PD display. The SD can be displayed as an overlay on the PD display screen. The method of the inventive player embodied in the system can apply to an audio SD on an audio PD e.g. a director's voiceover in the director's cut of a movie while the dialogue is still heard. It is noted that if the PD is audio, the embedding tool need only store the time code or other indicia of the temporal location, and the “object outline” would not apply.

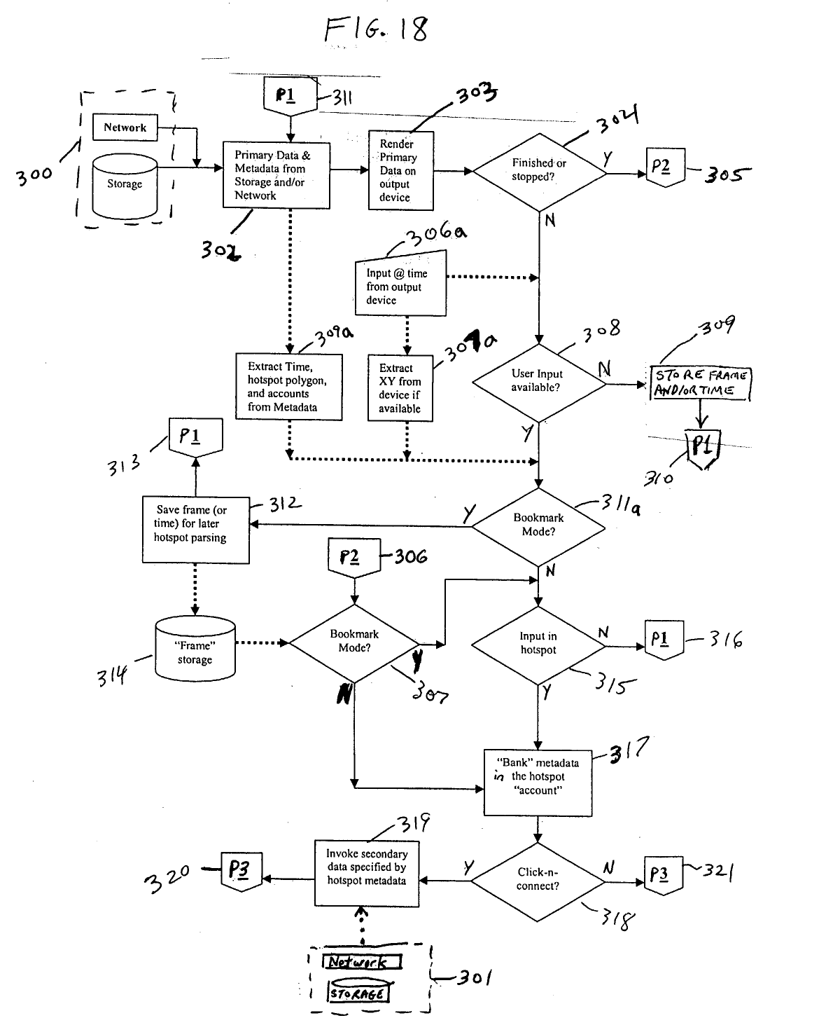

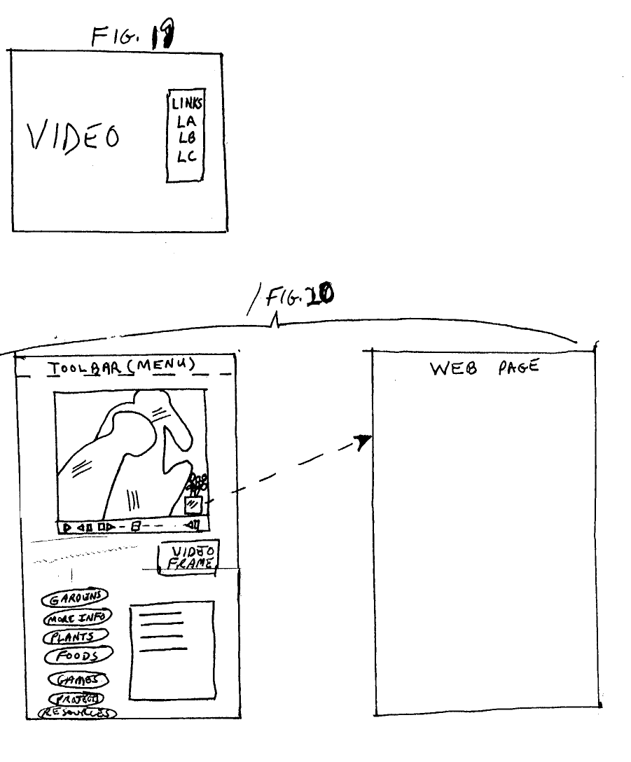

The player system may be described in further detail with reference to FIG. 18. The PD and MD may be stored at storage or network source 300, and the SD may be at storage or network source 301, which may be any combination of storage and/or network storage systems as described with reference to FIG. 22. At step 302, PD and MD are accessed from the source 300 and at step 303 the PD is shown on the output device, e.g., monitor screen, TV, PDA, etc. If the display or output device does not have a processor, a processor in the form of a device such as an adapter or box of a type similar to or the same as used in “web TV” may be used.

If the video ends or the user otherwise indicates that the player system should stop, at step 304, then the system will then ask if it is in bookmark mode (step 307) via steps 305 and 306 (P2).

If the player continues to play the video, the system goes from step 304 to step 308, where it determines if the user is able to provide location input, i.e., if the user has a mouse or other device to select an object, or if the user can only select the time code or frame of the video. If the user makes a selection, the system will store at step 309 the time and/or frame code (provided at element 306a) where the user has no input device capable of selecting an object. The system will also continue with the video at steps 302 and 303 via steps 310 and 311. If the user has an input device for selecting location, the system will take the time or frame where the PD video is currently, and mouse or input device's X, Y location data (elements 306a and 307a), and the time and/or frame data, location data (hot spot polygon) and MD (as needed) from the source 300 via step 309a, and will ask if the player is in bookmark mode (step 311a). If so, it will save the time/frame (and X, Y location) (and optionally the data from the source 300 though not necessarily) in storage 314 at step 312, and will return to the PD (via steps 313 and 311). The user may then, after the video is over, enter the player system at path P2 (step 306). If the system is again in bookmark mode (step 307a), the system will check if the user has clicked at a location having a hotspot (step 315). If the user only was able to bank a time code, and the user is now at a computer, the system can display any frame corresponding to the banked time code, and the user can click on an object. For this situation, or where the user was able to originally select the frame or time, and the object, the system sees if there is an actual hotspot at the selected time and location. If not, the system can send the user back to P1 (steps 316, 311) to review the PD and make another selection. If there is a hotspot, or if the user is not in bookmark mode, the system will bank the MD corresponding to the time code and object location at step 317, and then check to see if the user wants to display the SD (steps 318 to 319) by accessing the SD at source 301. If not, or after displaying the SD, the system can go to FIG. 22 (via connection P3 at 320 or 321) (e.g. at step 206) where the user is just viewing the SD data that he/she has selected and stored, and not viewing the PD.

The player system according to the invention may be embodied as a Java-based “player”—a set of programs (java methods in an applet) that allows clicking on PD to invoke SD via interaction with the MD. The player system may also be embodied as a Macromedia Flash 6-based player, or other software for display. The player is preferably embodied as a multi-threaded Java applet that contains several engines. Each of these engines handles a different aspect of the interaction between the PD, the MD files associated therewith and the acquisition of the SD. The player may also use MPEG format video, and the MD may even be encoded with the MPEG signal in one file. The embedding system may be a suite of C++, VB and MFC code, which may run on a Microsoft Windows operating system, or other operating system. The embedding tool also allows preferably allows the operator to drag-and-drop the SD “assets” onto the bounding rectangles—producing a MD and SD container that points to the SD associated with these video “hot spots”.

In a one-screen environment, such as FIG. 21, with TV 200 and without monitor 202, the audio/video PD is taken from some storage or transmission device along with either static or dynamic MD and is displayed (or played) on the single-screen. On this screen, invisible and overlaying the playing video is a Java “mouse listener” that manages the movement of the cursor over the video space. When the video is over a “hot spot” (as determined by the MD), the cursor changes form to let the viewer know that there is an interaction possibility using a common mouse/cursor click that we all have come familiar with. When the user clicks on the hot-spot on the video, depending on the type of interaction specified in the player's preferences and the type of data for the interaction set by the embedding tool, the click is at least remembered and the SD may be invoked. This could be a pop-up a menu or a stock ticker. The system may stop the video and play other video. Alternatively, the system may merely bookmark the current location and thumbnail the current frame for later review.

The player (both 1 and 2 screen) employs the notions of “accounts”—virtual containers, created by the embedding software and/or the user that are used to categorize the URLs to any external resource associated by the MD with the PD and the click. The clicks may be sorted to multiple accounts.

The GUI of the player system manages the activation of the interface methods and the invocation of the banked clicks (even if set for immediate use). The GUI displays the pop-up or scrolling lists of URLs (preferably by title, although it could be by http address) that the user can click on to invoke the associated SD page, audio, video or document.

The benefit of this preferred embodiment of the components of the player system is that any or all of the data types—PD, MD and SD—can be managed separately from each other and coordinated via user interaction in time and space from any location. That is, the PD can come from a DVD while the MD comes from another track on the DVD (-ROM) and the SD that is invoked can come as Internet web-pages associated with the clicks. This is shown in FIG. 3. PD can also come from a DTV video-transmission; the MD and SD can come over the ATVEF datacast stream (and be cached in the receiving device). By providing a manager of each type of data for both a one-screen-world and a two-screen world, each data type can be delivered to the ITV user as selected or desired for the application.

In the two-screen world, the player system works the same way, except that there are some features necessary to facilitate the interaction and synchronization. First, there is a server that runs at a data center that contains the “show” in still-image form—e.g., one image every second or one-half second. For a typical one-hour show, this would entail having 2640 jpeg images (44 minutes×60 images/minute) stored on the server. When the user starts to watch the “live” (on tape) program, they can be logged into the web site for the show. On their PC screen, while watching the TV program, the user can press a button on the interface “requesting” the frame from the television show at that particular moment. This causes the display to retrieve the correct image from the server and to display it on the user's web-browser and to bank the location in the appropriate video-bookmark account.

At the end of the show—or at any particular time later, the user can scroll through the “saved” images that were “requested” from the show and click on hot spots in these images. In this way the interaction between the PD and the MD to yield the SD can be time-shifted in the two-screen world. An example of one screen ITV with a Java-based player with a web page activated up by clicking the video is shown in FIG. 20. An example of two screen ITV with Java-based player is shown in FIG. 21.

What is claimed is:

1. A method of tracking an image of an object in a plurality of frames in a video, the video comprising multiple frames of images of objects, the method comprising the steps of:
selecting an image of at least one object in one frame of the video and assigning the object identifying data and the frame identifying data,
determining a location of the object in a frame, and storing the location information in association with the object and frame, and
tracking the object's image through multiple frames in the video and storing the location information in association with the object.

2. The method of claim 1 wherein the position information comprises an outline of the object.

3. The method of claim 1 wherein the video has at least two scenes, and the method further comprises the step of determining frames associated with each scene.

4. The method of claim 1 wherein the video comprising a signal containing data concerning the images of objects including color and hue, and the color and hue data are used to track the object.

5. The method of claim 4 wherein the color data and hue data are inputs to a neural net, and the neural net is used to track the object.

6. The method of claim 2 wherein the object outline information is used to track the object.

7. The method of claim 6 wherein color data and hue data are inputs to a neural net, and the neural net is used to track the object along with the object outline.

8. The method of claim 4 wherein color signal data, intensity, sin hue and cosine hue are inputs to the neural net.

9. The method of claim 4 wherein the method includes a step of revising the outline data for frames subsequent to the first frame.

10. The method of claim 1 wherein the object is tracked in each frame of the video.

11. The method of claim 1 wherein the object is tracked in at least every twelfth frame of the video, and the video having at least 24 frames per second.

12. The method of claim 1 wherein the object is tracked in at least every twelfth frame of the video, and the video having at least 24 frames per second, and the location of the objected is stored for at least every twelfth frame.

13. The method of claim 1 wherein in determining the object location, Fast Fourier Transforms are used.

14. A method of embedding links in association with an image of an object in multiple frames in a video, the video comprising multiple frames of images of objects, the method comprising the steps of:
selecting an image of at least one object in one frame of the video and assigning the object identifying data and the frame identifying data,
determining a location of the object in a frame, and storing the location information in association with the object and frame,
storing link information in association with the object identifying data and frame identifying data, and
tracking the object's image through multiple frames in the video and storing the location information in association with the object.

15. A method of playing a video having embedded links in association with an image of an object in multiple frames in a video, the video comprising multiple frames of images of objects, the method comprising the steps of:
Playing a video and displaying the video on a screen;
Selecting an image of at least one object in one frame of the video;
Determining a temporal location in the video when the object has been selected;
Comparing the selected temporal location with stored data concerning temporal location of at least one object in the video; and
Determining if there is data stored in association with the selected temporal location identifying at least one object at the selected temporal location;
and displaying the data stored in association with the temporal location.

16. The method of claim 15 wherein the selected object location is also compared with the stored data, the stored data containing object location data in the selected temporal location.

17. The method of claim 15 wherein the step of comparing occurs substantially at the same time as the step of selecting.

18. The method of claim 15 wherein the step of comparing occurs at a time remote from the step of selecting.

19. The method of claim 16 wherein the selected object location and temporal location are stored.

20. The method of claim 16 wherein the step of displaying comprises a step of accessing data from storage linked by data associated with the stored object location and temporal location.
